(19) United States
(12) Patent Application Publication
(10) Pub. No.: US 2017/0047608 A1
(43) Pub. Date: Feb. 16, 2017

(54) RECHARGEABLE LITHIUM BATTERY INCLUDING SAME

(71) Applicant: SAMSUNG SDI CO., LTD., Yongin-si (KR)

(72) Inventors: Dong-Hyun SHIN, Yongin-si (KR); Young-Kee KIM, Yongin-si (KR); Joon-Kil SON, Yongin-si (KR)

(21) Appl. No.: 15/188,874

(22) Filed: Jun. 21, 2016

(30) Foreign Application Priority Data
Aug. 13, 2015 (KR) 10-2015-0114724

(51) Int. Cl. H01M 10/0525; H01M 4/62; H01M 4/48; H01M 4/485; H01M 10/0561; H01M 4/131

(52) U.S. Cl. CPC H01M 10/0525; H01M 10/0561; H01M 4/131; H01M 4/483; H01M 4/485; H01M 4/625; H01M 10/0562

(57) ABSTRACT

A rechargeable lithium battery includes a negative electrode including a negative active material including titanium-containing oxide; a positive electrode including a positive active material represented by Chemical Formula 1, Chemical Formula 2 or a combination thereof and activated carbon; and an electrolyte:

LiₓMO_{2-z}L_{z} [Chemical Formula 1]

LiₓNi_{y}T_{1-y}O_{2-z}L_{z} [Chemical Formula 2]

Definitions of Chemical Formula 1 and 2 are the same as in the detailed description.

### RELATED APPLICATIONS

Any and all priority claims identified in the Application Data Sheet, or any correction thereto, are hereby incorporated by reference under 37 CFR 1.57. This application claims priority to and the benefit of Korean Patent Application No. 10-2015-0114724 filed in the Korean Intellectual Property Office on Aug. 13, 2015, the disclosure of which is incorporated in the entirety by reference.

### BACKGROUND

Field

A rechargeable lithium battery is disclosed.

Description of the Related Technology

As the environmental pollution problem has become serious, much research efforts has been dedicated towards development of low carbon next generation energy sources. Especially, since conventional gasoline and diesel vehicles cause environmental pollution, there has been an increase in research and development efforts for replacing the conventional vehicles with electric vehicles. Various types of a next generation vehicles such as an electric vehicle (EV), a hybrid electric vehicle (REV), a plug-in hybrid electric vehicle (PHEV), and the like have been developed depending on a combination of an engine and a battery, and a low voltage system (LVS) similar thereto but compatible with a conventional lead storage battery also has been actively developed.

A rechargeable lithium battery has a structure that an electrolyte solution including a lithium salt is impregnated into an electrode assembly including positive and negative electrodes and a porous separator interposed there between. A positive active material mainly comprises a lithium cobalt-based oxide, a lithium manganese-based oxide, a lithium nickel-based oxide, a lithium composite oxide, and the like, while a negative active material mainly comprises a carbon-based material.

However, a rechargeable lithium battery using the carbon-based material as a negative active material may have irreversible capacity generated from a part of lithium ions inserted into the layered structure of the carbon-based material during initial charge and discharge. In addition, the carbon material has a low oxidation/reduction potential of about 0.1 V relative to a Li/Li⁺ potential, and thus the electrolyte solution is decomposed on the surface of the negative electrode and reacts with lithium and thus forms a SEI (solid electrolyte interface) film on the surface. This SEI film may have a thickness and an interface state varying depending on an electrolyte solution system and has an influence on charge and discharge characteristics. Furthermore, however thin the SEI film is, the SEI film increases resistance in a rechargeable battery used in an area requiring high power characteristics and may bring about a RDS (rate determining step). In addition, a lithium compound is produced on the surface of the negative electrode and thus may deteriorate reversible capacity of lithium during repetitive charges and discharges and thus decrease discharge capacity and degrade a cycle life.

### SUMMARY

Some embodiments provide a rechargeable lithium battery having improved high-rate charge and discharge characteristics and cycle-life characteristics.

Another embodiment provides a rechargeable lithium battery including the negative electrode for a rechargeable lithium battery.

Some embodiments provide a rechargeable lithium battery including a negative electrode including a negative active material including titanium-containing oxide; a positive electrode including a positive active material represented by Chemical Formula 1, Chemical Formula 2, or a combination thereof, and activated carbon; and an electrolyte.

LiₓMO_{2-z}L_{z} [CHEMICAL FORMULA 1]

In Chemical Formula 1, M is M′ᵢ₋ₖAₖ (M′ is Ni_{1-d-e}Mn_{d}Coₑ, 0.1≦d+e≦0.5, 0.1≦d≦0.4, 0.1≦e≦0.4, A is a dopant and 0≦k<0.05); L is F (fluorine), S (sulphur), P (phosphorous), or a combination thereof, 0.95≦x≦1.05, and 0≦z≦2.

LiₓNi_{y}T_{1-y}O_{2-z}L_{z} [CHEMICAL FORMULA 2]

In Chemical Formula 2, T is Al, Co, Mn, Cr, Fe, Mg, Sr, a rare earth element, or a combination thereof,
L is F (fluorine), S (sulphur), P (phosphorous), or a combination thereof, 0.95≦x≦1.05, 0.5≦y≦0.9, and 0≦z≦2.

In some embodiments, the activated carbon may be included in an amount of about 1 wt % to about 15 wt % based on the total weight of the positive active material and the activated carbon. In some embodiments, the activated carbon may be included in an amount of about 1 wt % to about 10 wt % based on the total weight of the positive active material and the activated carbon. In some embodiments, the activated carbon may be included in an amount of about 1 wt % to about 5 wt % based on the total weight of the positive active material and the activated carbon.

In some embodiments, the titanium-containing oxide may include TiO₂, LiTiO₂, LiTi₂O₄, Li₄Ti₅O₁₂, or a combination thereof

In some embodiments, the titanium-containing oxide may have a particle diameter (D50) of about 1 μm to about 30 μm. In some embodiments, the titanium-containing oxide may have a particle diameter (D50) of about 3 μm to about 10 μm.

In some embodiments, the activated carbon may have a specific surface area of about 1000 m²/g to about 3000 m²/g. In some embodiments, the activated carbon may have a specific surface area of about 1200 m²/g to about 2000 m²/g

In some embodiments, the activated carbon may have a particle diameter (D50) of about 1 μm to about 30 μm. In some embodiments, the activated carbon may have a particle diameter (D50) of about 1 μm to about 20 μm

In some embodiments, the negative electrode may further include activated carbon. In some embodiments, the activated carbon may be included in an amount of about 1 wt % to about 15 wt % based on the total amount of the titanium-containing oxide and the activated carbon. In some embodiments, the activated carbon may be included in an amount of about 1 wt % to about 10 wt % based on the total amount of the titanium-containing oxide and the activated carbon. In some embodiments, the activated carbon may be included in an amount of about 1 wt % to about 5 wt % based on the total amount of the titanium-containing oxide and the activated carbon.

Other embodiments are included in the following detailed description.

In some embodiments, the rechargeable lithium battery may have excellent high-rate charge and discharge characteristics.

### BRIEF DESCRIPTION OF THE DRAWINGS

FIG. 1 is a schematic view of a rechargeable lithium battery according to one embodiment.

FIG. 2 is a graph showing output characteristics of rechargeable lithium battery cells according to Examples 1 to 3 and Comparative Examples 1 to 4.

### DETAILED DESCRIPTION

Hereinafter, embodiments are described in detail. However, these embodiments are exemplary, the present disclosure is not limited thereto and the present disclosure is defined by the scope of claims.

Hereinafter, a rechargeable lithium battery according to one embodiment is described.

A rechargeable lithium battery according to one embodiment includes a negative electrode including a negative active material including a titanium-containing oxide; a positive electrode including a positive active material represented by Chemical Formula 1, Chemical Formula 2, or a combination thereof, and activated carbon; and an electrolyte.

LiₓMO_{2-z}L_{z} [CHEMICAL FORMULA 1]

In Chemical Formula 1, M is M′₁₋ₖAₖ (M′ is Ni_{1-d-c}Mn_{d}Coₑ, 0.1≦d+e≦0.5, 0.1≦d≦0.4, 0.1≦e≦0.4, A is a dopant, and 0≦k≦0.05);
L is F (fluorine), S (Sulphur), P (phosphorous), or a combination thereof,
0.95≦x≦1.05, and
0≦z≦2.

LiₓNi_{y}T_{1-y}O_{2-z}L_{z} [CHEMICAL FORMULA 2]

In Chemical Formula 2, T is Al, Co, Mn, Cr, Fe, Mg, Sr, a rare earth element, or a combination thereof,

L is F (fluorine), S (sulphur), P (phosphorous), or a combination thereof,
0.95≦x≦1.05,
0.5≦y≦0.9, and
0≦z≦2.

The activated carbon may be included in an amount of about 1 wt % to about 15 wt %, for example, about 1 wt % to about 10 wt %, about 1 wt % to about 5 wt % based on total amount of the positive active material and the activated carbon. When the activated carbon is included within the amount range, high-rate charge and discharge characteristics are improved and excellent cycle-life characteristics are also achieved. When the activated carbon is included within the amount range, excellent capacitance capacity and total battery capacity, and in addition, appropriate dispersion and active mass density may be obtained.

According to one embodiment, the positive electrode uses a lithium metal oxide positive active material represented by the above Chemical Formulas 1 or 2, wherein, a high-content nickel compound including greater than or equal to about 50 mol % of nickel based on the total mol % of a metal as a positive active material and further, includes activated carbon and thus result in improved high rate capability.

This can be attributed to the fact that the activated carbon adsorbs and desorbs and also, intercalates and deintercalates anions hindering movement of lithium ions in negative and positive electrodes and thus decreases a battery resistance. This results in formation of a capacitor structure and thus physically adsorbs the lithium ions rapidly transfers the adsorbed lithium ions to the positive active material and as a result has improved high-rate charge and discharge characteristics. In addition, the activated carbon is added thereto and uniformly dispersed among the active material, thus forms a uniform electrode and suppresses deterioration of a part of the electrode, and may achieve excellent cycle-life characteristics.

The effect of using the activated carbon may be maximized in the high-content nickel compound using nickel in an amount of greater than or equal to about 50 mol % based on the total mol % of a metal. Therefore, the activated carbon may address the problem of deterioration of high rate capability and cycle-life characteristics of the high-content nickel compound due to lower stability, than a low content nickel compound including nickel in an amount of less than about 50 mol %.

The activated carbon may have a specific surface area of about 1000 m²/g to about 3000 m²/g, for example, about 1200 m²/g to about 2000 m²/g. When the specific surface area is within the range, a battery having excellent dispersity and improved high-rate charge and discharge characteristics and cycle-life characteristics is achieved.

The activated carbon may have a particle diameter (D50) of about 1 μm to about 30 μm, for example, about 1 μm to about 20 μm. The particle diameter (D50) indicates a diameter where an accumulated volume is 50 volume % in a particle distribution. When the activated carbon has an average particle diameter (D50) within the range, particles may not be agglomerated and prevented from being localized in a particular region, and thus high-rate charge and discharge characteristics are achieved.

The positive electrode includes a positive active material layer including the positive active material and the activated carbon and a current collector supporting the positive active material layer.

The positive active material layer may further include a conductive material and a binder.

The conductive material improves conductivity of a positive electrode. Any electrically conductive material may be used as a conductive material, unless it causes a chemical change. Examples of the conductive material include a carbon-based material such as natural graphite, artificial graphite, carbon black, acetylene black, ketjen black, a carbon fiber and the like; a metal-based material such as of a metal powder or a metal fiber including copper, nickel, aluminum, silver, and the like; a conductive polymer such as a polyphenylene derivative; or a mixture thereof.

The binder improves binding properties of positive active material particles with one another and with a current collector. Examples of the binder may be polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, p olytetrafluoro ethylene, polyvinylidene fluoride, polyethylene, polypropylene, a styrene-butadiene rubber, an acrylated styrene-butadiene rubber, an epoxy resin, nylon, and the like, but are not limited thereto.

The current collector may be aluminum, but is not limited thereto.

The titanium-containing oxide may include titanium oxide, lithium titanium oxide or a combination thereof The titanium oxide may include TiO₂, and the lithium titanium oxide may include LiTiO₂, LiTi₂O₄, Li₄Ti₅O₁₂ or a combination thereof, for example, Li₄Ti₅O₁₂.

When the titanium-containing oxide is used as a negative active material for a rechargeable lithium battery, an electrolyte solution is not decomposed, since the oxidization/reduction potential of a negative electrode is relatively high, about 1.5 V versus a Li/Li⁺ potential, and excellent cycle characteristics may be obtained due to stability of the crystal structure.

The titanium-containing oxide may have an average particle diameter (D50) of about 1 μm to about 30 μm, for example, about 3 μm to about 10 μm. The average particle diameter (D50) indicates a diameter where an accumulated volume is about 50 volume % in a particle distribution. When the titanium-containing oxide has a particle diameter (D50) within the range, excellent dispersity and high active mass density may be obtained during manufacture of a negative electrode, and thus capacity and high-rate charge and discharge characteristics may be improved.

The negative electrode may further include activated carbon. When activated carbon is further used for the negative electrode, high-rate charge and discharge characteristics of a rechargeable lithium battery may be improved, and excellent cycle-life characteristics may be achieved.

When the activated carbon is further included, a content of the activated carbon may be about 1 wt % to about 15 wt %, for example, about 1 wt % to about 10 wt %, about 1 wt % to about 5 wt % based on the total weight of the titanium-containing oxide and the activated carbon. When the activated carbon is included within the amount range, excellent capacity characteristics and cycle-life characteristics may be obtained, and high-rate charge and discharge characteristics may be achieved.

The activated carbon may have a specific surface area of about 1000 m²/g to about 3000 m²/g, for example, about 1200 m²/g to about 2000 m²/g. When the specific surface area is within the range, excellent dispersity may be obtained, and high-rate charge and discharge characteristics and cycle-life characteristics may be accomplished.

The activated carbon may have a particle diameter (D50) of about 1 μm to about 30 μm, for example, about 1 μm to about 20 μm. The particle diameter (D50) indicates a particle where an accumulated volume is about 50 volume % in a particle distribution. When the activated carbon has a particle diameter (D50) within the range, particles may not be agglomerated and prevented from being localized in a particular region, and thus high-rate charge and discharge characteristics may be improved.

The negative electrode may include a negative active material layer including the negative active material, optionally activated carbon, and a current collector supporting the negative active material layer.

The negative active material layer may further include a binder in addition to the negative active material, optionally a conductive material.

The binder improves binding properties of negative active material particles with one another and with a current collector, and examples thereof may be polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, p olytetrafluoro ethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves conductivity of a negative electrode. Any electrically conductive material may be used as a conductive material, unless it causes a chemical change. Examples of the conductive material include a carbon-based material such as natural graphite, artificial graphite, carbon black, acetylene black, ketjen black, a carbon fiber and the like; a metal-based material such as of a metal powder or a metal fiber including copper, nickel, aluminum, silver, and the like; a conductive polymer such as a polyphenylene derivative; or a mixture thereof.

The current collector may include copper, but is not limited thereto.

The negative electrode may be manufactured by a method including mixing the negative active material, a binder, and optionally the conductive material in a solvent to prepare a negative electrode composition, and coating the negative electrode composition on the current collector followed by compressing and drying the resulting current collector. The solvent includes N-methylpyrrolidone, water and the like, but is not limited thereto.

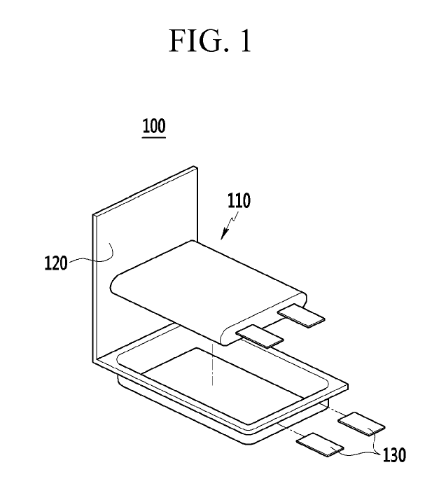

FIG. 1 is a schematic view showing a rechargeable lithium battery according to one embodiment.

Referring to FIG. 1, a rechargeable lithium battery 100 according to one embodiment includes an electrode assembly 110, a battery case 120 housing the electrode assembly 110, and an electrode tab 130 playing a role of an electrical channel for externally inducing a current formed in the electrode assembly 110. Both sides of the battery case 120 are overlapped and sealed. In addition, an electrolyte solution is injected into the battery case 120 housing the electrode assembly 110. The electrode assembly 110 includes a positive electrode, a negative electrode facing the positive electrode, and a separator interposed between the negative electrode and the positive electrode.

The rechargeable lithium battery according to one embodiment is not limited to the shape of FIG. 1, and may have any shape such as cylindrical, prismatic, coin-type, or pouch if the rechargeable lithium battery including the negative electrode is operable.

The electrolyte solution includes a non-aqueous organic solvent and a lithium salt.

The non-aqueous organic solvent serves as a medium for transmitting ions taking part in the electrochemical reaction of a battery. The non-aqueous organic solvent may be selected from a carbonate-based, ester-based, ether-based, ketone-based, alcohol-based and aprotic solvent.

The carbonate-based solvent may be, for example dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like.

When the carbonate-based solvent is prepared by mixing a cyclic carbonate and a linear carbonate, a solvent having a low viscosity while having an increased dielectric constant may be obtained. The cyclic carbonate and the linear carbonate are mixed together in the volume ratio of about 1:1 to 1:9.

The ester-based solvent may include, for example methyl acetate, ethyl acetate, n-propyl acetate, dimethyl acetate, methyl propionate, ethyl propionate, γ-butyrolactone, decanolide, valerolactone, mevalonolactone, caprolactone, or the like. The ether-based solvent may include, for example dibutylether, tetraglyme, diglyme, dimethoxyethane, 2-methyltetrahydrofuran, tetrahydrofuran, and the like, and the ketone-based solvent may include cyclohexanone, and the like. The alcohol-based solvent may include ethanol, isopropyl alcohol, and the like.

The non-aqueous organic solvent may be used singularly or in a mixture. When the organic solvent is used in a mixture, the mixture ratio may be controlled in accordance with a desirable battery performance.

The non-aqueous electrolyte solution may further include an overcharge-inhibiting additive such as ethylene carbonate, pyrocarbonate, and like.

The lithium salt dissolved in the non-aqueous organic solvent supplies lithium ions in the battery, and operates a basic operation of a rechargeable lithium battery and improves lithium ion transportation between positive and negative electrodes.

Specific examples of the lithium salt may include one selected from LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CF₂F₂ₓ₊₁SO₂)(C_{y}F_{2y+1}SO₂) (wherein x and y are natural numbers, for example an integer ranging from 1 to 20), LiCl, LiI, LiB(C₂O₄)₂ (lithium bis(oxalato) borate; LiBOB), and a combination thereof.

The lithium salt may be used at a concentration ranging from about 0.1 M to about 2.0 M. When the lithium salt is included at the concentration range, an electrolyte solution may have excellent performance and lithium ion mobility due to appropriate conductivity and viscosity of an electrolyte solution.

The separator may include any materials commonly used in the conventional lithium battery as long as separating the negative electrode from the positive electrode and providing a transporting passage of lithium ion. In other words, it may have a low resistance to ion transport and an excellent impregnation for electrolyte solution. For example, it may be selected from glass fiber, polyester, polyethylene, polypropylene, polytetrafluoroethylene (PTFE), or a combination thereof It may have a form of a non-woven fabric or a woven fabric. For example, a polyolefin-based polymer separator such as polyethylene, polypropylene or the like is mainly used. In order to ensure the heat resistance or mechanical strength, a coated separator including a ceramic component or a polymer material may be used. Optionally, it may have a mono-layered or multi-layered structure.

Hereinafter, the embodiments are illustrated in more detail with reference to examples. However, these examples are exemplary, and the present disclosure is not limited thereto.

### Manufacture of Rechargeable Lithium Battery Cell

### EXAMPLE 1

LiNi_{0.5}Co_{0.2}Mn_{0.3}O₂ having an average particle diameter (D50) of 5 μm, activated carbon having an average particle diameter (D50) of 6.8 μm (a specific surface area: 1500 m²/g, YP50F, Kuraray Co., Ltd.; Tokyo, Japan), carbon black (denka black), and polyvinylidene fluoride in a weight ratio of 85:5:4:6 were mixed with N-methylpyrrolidone, preparing slurry. The prepared slurry was coated on a 15 μm-thick aluminum foil, dried, and compressed, manufacturing a positive electrode.

On the other hand, Li₄Ti₅O₁₂ having a particle diameter (D50) of 5 μm, carbon black (denka black), and polyvinylidene fluoride in a weight ratio of 89:5:6 were mixed with N-methylpyrrolidone, thus preparing a slurry. The slurry was coated on a 15 μm-thick copper foil, dried, and compressed, manufacturing a negative electrode.

The positive and negative electrodes were used with a separator made of a polyethylene material to form an electrode assembly, and an electrolyte solution was implanted thereinto, manufacturing a 50 mAh pouch-type rechargeable lithium battery cell. Herein, the electrolyte solution was prepared by mixing ethylene carbonate (PC), ethylmethyl carbonate (DMC), and diethyl carbonate (DEC) in a volume ratio of 2:6:2 and adding 1.15 M LiPF₆ to the mixed solvent.

### EXAMPLE 2

A rechargeable lithium battery was manufactured according to the same method as Example 1 except for using a positive electrode manufactured by using LiNi_{0.6}Co_{0.2}Mn_{0.2}O₂ instead of the LiNi_{0.5}Co_{0.2}Mn_{0.3}O₂ as a positive active material.

### EXAMPLE 3

A rechargeable lithium battery was manufactured according to the same method as Example 1 except for using a positive electrode manufactured by using a mixture of LiNi_{0.5}Co_{0.2}Mn_{0.3}O₂ and LiNi_{0.8}CO_{0.15}Al_{0.05}B_{0.01}O₂ (a weight ratio of 9:1) instead of the LiNi_{0.5}Co_{0.2}Mn_{0.3}O₂ as a positive active material.

### COMPARATIVE EXAMPLE 1

LiNi_{1/3}Co_{1/3}Mn_{1/3}O₂ having a particle diameter (D50) of 5 μm, carbon black (denka black), and polyvinylidene fluoride in a weight ratio of 89:4:6 were mixed with N-methylpyrrolidone, preparing slurry. The slurry was coated on a 15 μm-thick aluminum foil, dried, and compressed, manufacturing a positive electrode.

On the other hand, Li₄Ti₅O₁₂ having a particle diameter (D50) of 5 μm, carbon black (denka black), and polyvinylidene fluoride in a weight ratio of 89:5:6 were mixed with N-methylpyrrolidone, preparing a slurry. The slurry was coated on a 15 μm-thick copper foil, dried, and compressed, manufacturing a negative electrode.

The positive and negative electrodes were used with a separator made of a polyethylene material to form an electrode assembly, and an electrolyte solution was implanted thereinto, manufacturing a 50 mAh pouch-type rechargeable lithium battery cell. Herein, the electrolyte solution was prepared by mixing ethylene carbonate (PC), ethylmethyl carbonate (DMC), and diethyl carbonate (DEC) in a volume ratio of 2:6:2 and dissolving 1.15 M LiPF₆ in the mixed solvent.

### COMPARATIVE EXAMPLE 2

A rechargeable lithium battery cell was manufactured according to the same method as Comparative Example 1 except for using a positive electrode manufactured by using LiNi_{0.5}Co_{0.2}Mn_{0.3}O₂ instead of the LiNi_{1/3}Co_{1/3}Mn_{1/3}O₂ as a positive active material.

### COMPARATIVE EXAMPLE 3

A rechargeable lithium battery cell was manufactured according to the same method as Comparative Example 1 except for using a positive electrode manufactured by using LiNi_{0.6}Co_{0.2}Mn_{0.2}O₂ instead of the LiNi_{1/3}Co_{1/3}Mn_{1/3}O₂ as a positive active material.

### COMPARATIVE EXAMPLE 4

A rechargeable lithium battery cell was manufactured according to the same method as Comparative Example 1 except for using a positive electrode manufactured by using a mixture of LiNi_{0.5}Co_{0.2}Mn_{0.3}O₂ and LiNi_{0.8}CO_{0.15}Al_{0.05}B_{0.01}O₂ (a weight ratio of 9:1) instead of the LiNi_{1/3}Co_{1/3}Mn_{1/3}O₂ as a positive active material.

### Evaluation 1: High-Rate Charge and Discharge Characteristics

The rechargeable lithium battery according to Examples 1 to 3 and Comparative Examples 1 to 4 were once charged and discharged at 0.2 C, and their discharge capacity was measured. The results are provided in the following Table 1.

In addition, the rechargeable lithium battery cells according to Examples 1 to 3 and Comparative Examples 1 to 4 were once charged and discharged at 1 C and 10 times charged and discharged at 50 C, and their ratios of 50 C discharge capacities relative to 1 C discharge capacities were provided as 50 C rate capability in the following Table 1.

TABLE 1

| | 0.2 C discharge | 50 C rate |
|---|---|---|
| | capacity (mAh) | capability (%) |
| Comparative Example 1 | 58.2 | 77.9 |
| Comparative Example 2 | 59.4 | 74.3 |
| Comparative Example 3 | 62.4 | 75.5 |
| Comparative Example 4 | 69.1 | 75.9 |
| Example 1 | 58.9 | 76.8 |
| Example 2 | 61.0 | 78.9 |
| Example 3 | 68.2 | 79.1 |

As shown in Table 1, the cells according to Examples 1 to 3 showed excellent high rate capability at 50 C compared with the cells according to Comparative Examples 1 to 4. In particular, the cells according to Examples 1 to 3 showed about 2.5% to 3.2% improved high rate capability compared with the cells according to Comparative Examples 2 to 4.

### Evaluation 2: Output Characteristics

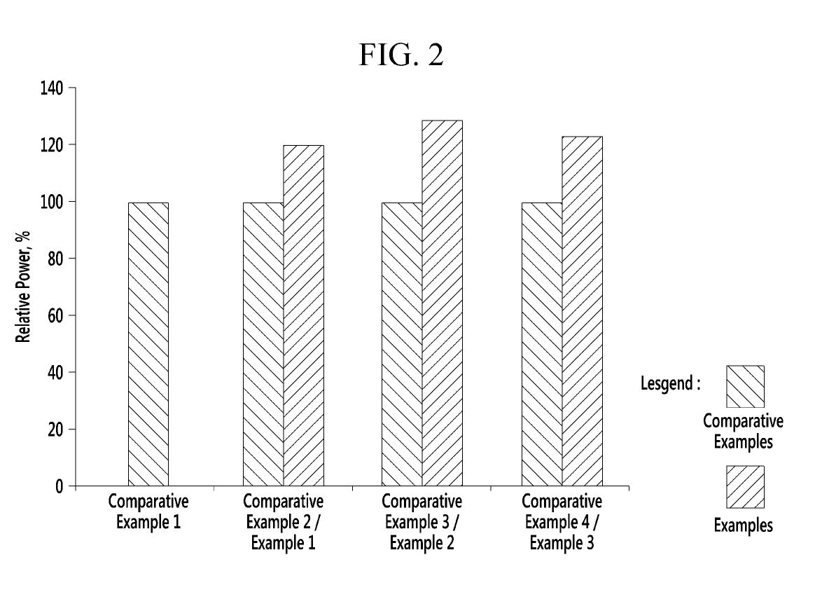

Output (Power) characteristics of the rechargeable lithium battery cells according to Examples 1 to 3 and Comparative Examples 1 to 4 were measured. The output characteristics were evaluated by charging the cells under SOC 50% in a J pulse method and discharged through 4 steps of 1 C, 5 C, 10 C, and 20 C for 10 seconds and measuring their outputs. The cells were discharged for 10 seconds in each step and charged at 1 C to become SOC 50% at each C-rate. Herein, a SOC 50% condition indicates that a cell was charged up to 50% charge capacity based on 100% of the total charge capacity of the cell. The results are provided in FIG. 2.

As shown in FIG. 2, the rechargeable lithium battery cells according to Examples 1 to 3 showed excellent output characteristics compared with the cells according to Comparative Examples 1 to 3. Particularly, the rechargeable lithium battery cells according to Examples 1 to 3 showed excellent improvement in the output characteristics.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A rechargeable lithium battery comprising:
a negative electrode including a negative active material including titanium-containing oxide;
a positive electrode including a positive active material represented by Chemical Formula 1, Chemical Formula 2 or a combination thereof and activated carbon; and
an electrolyte:
LiₓMO₂₋ₓL_{z} [Chemical Formula 1]
wherein, M is M′₁₋ₖAₖ (M′ is Ni_{1-d-e}Mn_{d}Coₑ, 0.1≦d+e≦0.4, 0.1≦d≦0.4, 0.1≦e≦0.4, A is a dopant and 0≦k≦0.05);
L is F (fluorine), S (Sulphur), P (phosphorous), or a combination thereof,
0.95≦x≦1.05, and
0≦z≦2,
LiₓNi_{y}T_{1-y}O_{2-z}L_{z} [Chemical Formula 2]
wherein, T is Al, Co, Mn, Cr, Fe, Mg, Sr, a rare earth element, or a combination thereof,
L is F (fluorine), S (Sulphur), P (phosphorous), or a combination thereof,
0.95≦x≦1.05,
0.5≦y≦0.9, and
0≦z≦2.

2. The rechargeable lithium battery of claim 1, wherein the activated carbon is included in an amount of about 1 wt % to about 15 wt % based on the total weight of the positive active material and the activated carbon.

3. The rechargeable lithium battery of claim 1, wherein the titanium-containing oxide comprises TiO₂, LiTiO₂, LiTi₂O₄, Li₄Ti₅O₁₂, or a combination thereof.

4. The rechargeable lithium battery of claim 1, wherein the titanium-containing oxide has a particle diameter (D50) of about 1 μm to about 30 μm.

5. The rechargeable lithium battery of claim 1, wherein the activated carbon has a specific surface area of about 1000 m²/g to about 3000 m²/g.

6. The rechargeable lithium battery of claim 1, wherein the activated carbon has a particle diameter (D50) of about 1 μm to about 30 μm.

7. The rechargeable lithium battery of claim 1, wherein the negative electrode further comprises activated carbon.

8. The rechargeable lithium battery of claim 1, wherein the negative electrode further comprises activated carbon, and the activated carbon is included in an amount of about 1 wt % to about 15 wt % based on the total amount of the titanium-containing oxide and the activated carbon.
